(19) United States
(12) Patent Application Publication
(10) Pub. No.: US 2009/0249226 A1
(43) Pub. Date: Oct. 1, 2009

(54) COLLABORATIVE TOOL USE IN VIRTUAL ENVIRONMENT

(75) Inventors: Dragos A. Manolescu, Kirkland, WA (US); Peter Gerard Provost, Denver, CO (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/057,379

(22) Filed: Mar. 28, 2008

(51) Int. Cl. G06F 3/048

(52) U.S. Cl. 715/757

(57) ABSTRACT

A collaborative tool is integrated into a virtual collaborative environment. The collaborative tool allows use of the tool by one or more physically remote users while providing full functionality and features which may not be available in the virtual collaborative environment. A substantially seamless transition is had between using the tool in the virtual environment and the real world.

### BACKGROUND

Computers and networks are widely used to enhance productivity in business environments. One way that productivity is increased is through the use of collaborative work environments to create a workgroup session which allow remotely located participants to interact across communications networks. Multiple users may connect to a server, for example, to create a workgroup session during which all of the participants view a shared work space. The participants may take turns editing a document or providing input to the shared workspace. Each participant contemporaneously views changes made by any other participant.

In some workgroup applications, the network interconnecting the client computers is also used to transmit voice or video signals. Participants in a workgroup application session may use this capability to talk with each other during a workgroup application session or share pictures or other video information.

Examples of workgroup applications that are commercially available include LIVE MEETING™ provided by Microsoft Corporation of Redmond, Wash., VIRTUAL OFFICE™ provided by Groove Networks, Inc. of Beverly, Mass. and WEBEX™ offered by WebEx Communications, Inc.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, one or more developmental or other type of collaborative tools are integrated into a virtual collaborative work environment. The virtual collaborative work environment provides a locus of collaboration in that it allows users to interact from physically disparate locations while benefiting from use of all of the features and functions of collaborative tools available in the real world, which may not be accessible in the virtual world (at least not to the same degree of functionality and/or user experience), and thus allows users to maintain a collaborative flow.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is flow chart illustrating an exemplary method of using a virtual collaborative work environment having one or more collaborative tools integrated therein.

FIG. 2 is an illustration of a virtual collaborative environment of a collaborative effort having three users.

FIG. 3 is a component block diagram illustrating an exemplary system for integrating a collaborative tool in the real world with a virtual collaborative work environment for use by one or more participants.

FIG. 4 is an illustration of one embodiment of an exemplary application of a method of using a virtual collaborative work environment.

FIG. 5 is an illustration of a computer-readable medium comprising processor-executable instructions configured to apply one or more of the techniques presented herein

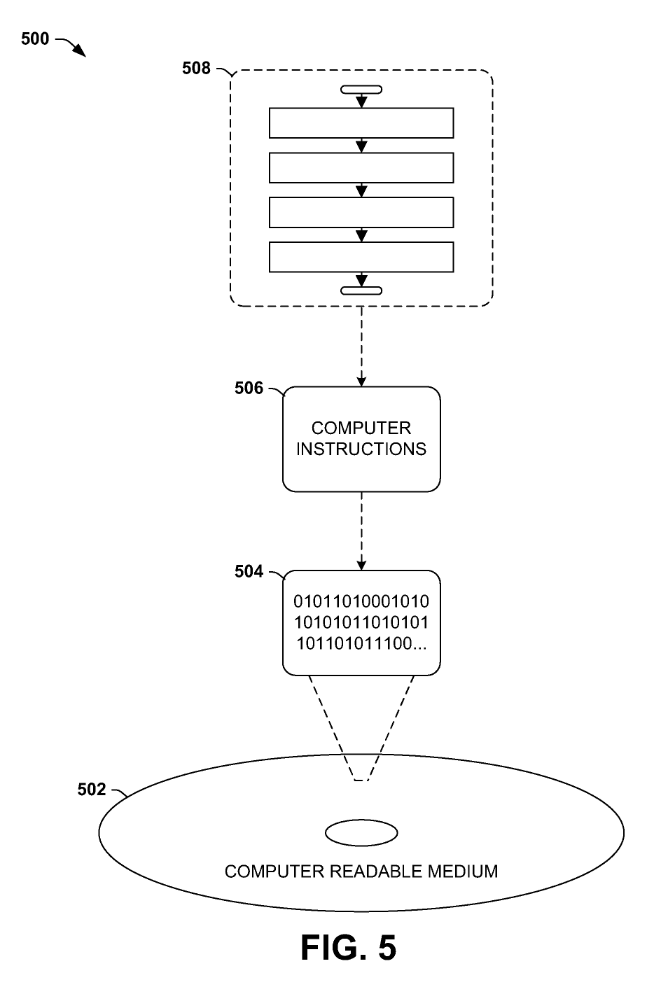

FIG. 6 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Video and telephone conferencing have been widely used technologies to address the need for remotely located collaborators to work together and share information. As technology has progressed, the use of virtual environments to provide a locus of collaboration for collaborative work has become more common. That is, virtual environments provide an immersive experience that is advantageous over traditional video and telephone conferencing technologies.

One such tool for collaboration in a virtual environment is a “shared whiteboard” which allows multiple users who may be physically dispersed to interact simultaneously on the same locus of collaboration. The whiteboard and its contents are visible to users through a display on users' respective workstations. The whiteboard can function so as to allow users to view, write, modify and/or delete contents displayed thereon, and users are able to view simultaneously changes made to the whiteboard.

The collaborative tools currently available within the virtual environment which provide collaborative resources to users are constrained, however, by the limitations of the virtual environment in which they are operated. Such tools often do not provide the same functions and features which are available when operated in the real world. Thus, while it is still possible to utilize a real world tool to benefit from the features available there, this requires users to leave the virtual environment and disrupts the flow of collaboration between users.

By utilizing the collaborative work environment and the collaborative tools within the environment, users can share the same collaborative work environment and can effectively communicate and interact with one another to the extent as if they were actually meeting and working in person, while simultaneously having available to them all of the capabilities and functionality of the collaborative tool as provided in the real world. By use in the real world, it is meant that the tool is not interactively presented and/or embodied within the virtual world.

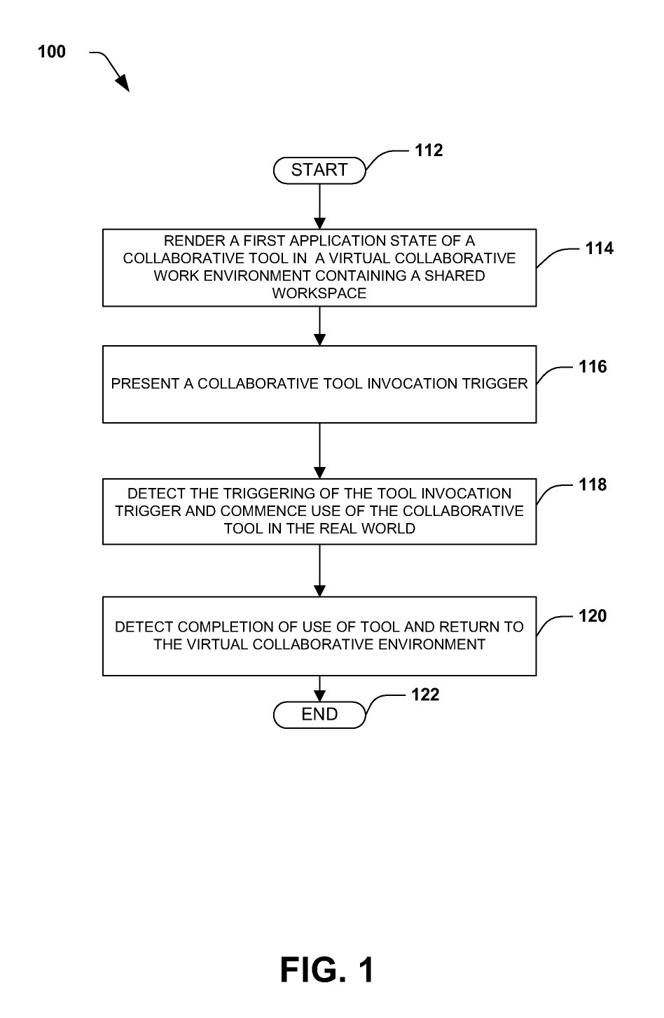

One method for using collaborative tools within a virtual collaborative environment is detailed in the following description. FIG. 1 illustrates a flowchart diagram of an exemplary method 10 by which one or more users may collaborate in a virtual environment using a collaborative tool. The exemplary method 100 begins at 112, and involves rendering of a first application state of a collaborative tool in a virtual collaborative environment (VCE) at 114. The VCE contains a shared workspace or “whiteboard” having the a first application state of the collaborative tool (CT) thereon with which users can interact. The exemplary method also involves presentation of a collaborative tool invocation trigger at 116 such that upon detection of triggering of the invocation trigger, users may commence use of the collaborative tool in the real world at 118. When users have completed use of the collaborative tool in the real world, the cessation of use is detected and users are returned to the VCE at 120. Having achieved use of the tool in the real world, the exemplary method 100 ends at 122.

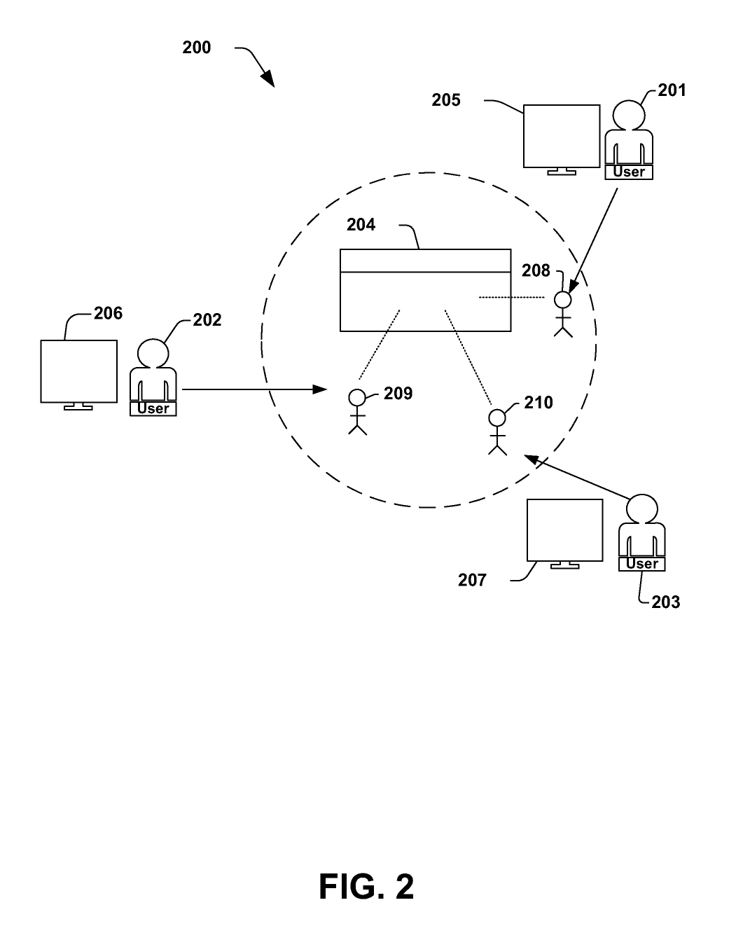

FIG. 2 illustrates a graphical display of a virtual collaborative environment (VCE) 200 for a collaborative effort having three participants or users 201, 202 and 203. A shown in FIG. 2, the VCE 200 comprises, for example, a meeting room having a shared workspace illustrated as a whiteboard 204. The VCE 200, the whiteboard 204 and its contents are visible to users 201, 202, 203 through a display on the participant's workstation 205, 206, 207. Users 201, 202 and 203 are pictured within the VCE 200 as graphical representations or “avatars” 208, 209, 210, respectively. The avatars 208, 209, 210 can be created by a user, or the users can select from a predefined set of characters. Avatars 208, 209, 210 move within the VCE 200 based upon a user selecting a desired location with the VCE 200. Users 201, 202, 203 may also communicate within the VCE 200, for example, by audio command, webcam, mouse gesture and/or text discussion.

The whiteboard 204 functions as a location where a collaborative tool from the real world and alterations within the collaborative tool can be rendered. While some collaborative tools may intrinsically provide collaboration, it will be understood that the techniques discussed herein may be applied to any sort of computer program, e.g., document readers, audio and video players, and the like, and can include, for example, computer programs that function within the real world environment and provide features which may not be generally available within the virtual environment to assist in collaboration efforts between users. Such tools can include programs having video and/or audio components, for example, a software integrated development tool, a drawing tool, a collaborative meeting tool, and the like. The common trait across these applications being that they support collaborative work, which is why users employ them first in the virtual world, and then in the real world.

Users 201, 202, 203 can collaborate using a collaborative tool which has been pre-configured to reflect the collaboration in the VCE 200. The CT can be pre-configured, for example, such that upon start-up of the CT, the tool is in a condition to render the first application state. Features to be pre-configured can include, for example, text color to assist in distinguishing between users, specific information about the users, restrictions to access to the collaborative tool, for example, where a user can view or listen but cannot interact with the collaborative tool, among others.

One aspect that may vary among embodiments of these techniques relates to the interaction of the tool with the users. In one variation, the tool may simply provide a shared user experience, for example, a “read-only” file, such as a video that the users watch together and discuss. In another variation, the tool may also accept input from one or more users. As a first example, the second application state might comprise a different view of a data item. As a second example, the second application state might comprise an alteration of a data item, e.g., an insertion of text by the users into a shared document. As a third example, the second application state might comprise a response to a command received from a user, such as a menu selection or button-click, that produces a new program mode, such as a transition to or from a sub-menu. In this variation, the tool may respond by generating a second application state and sending it to the users, which may be followed by additional input and a third application state, etc. Those of ordinary skill in the art may devise many techniques for configuring the tool to receive and process input while implementing the techniques discussed herein.

In one embodiment, the VCE 200 can include more than one collaborative tool available to users within the VCE 200. For example, in one embodiment, the environment 200 can include more than one shared workspace or whiteboard 204, the shared workspaces representing a different collaborative tool such that upon completion of interaction with one tool, the user can move to and interact with a different whiteboard 204 and tool in the VCE 200. Additional whiteboards 204 may be displayed in the VCE 200, or, alternatively, different whiteboards 204 may be identified by an index tab or selection box within the VCE 200 which users can select to move to the different whiteboard 204.

The CT may be rendered on the whiteboard 204 in the VCE 200 in a first application state. In one embodiment, the CT is rendered as a graphical representation of the tool to be used. For example, where a drawing tool is to be utilized, the first application state may be a blank page from the drawing tool. In another embodiment, where the tool to be utilized is an audio tool, the first application state may be a graphic of an audioplayer. In a further embodiment, where the tool is a document reader, the first application state may be an illustration of the document to be read. Those of ordinary skill in the art will recognize further alternatives for rendering of the first application state as set forth herein.

Users 201, 202, 203 commence use of the CT on whiteboard 204 by triggering a CT invocation trigger. In one embodiment, VCE 200 may be preconfigured to sense a proximity locator near the whiteboard. For example, as users' avatars 208, 209, 210 move toward the whiteboard 204, upon reaching a predetermined distance from the whiteboard, commencement of use of the CT is initiated. In another embodiment, the trigger may be a “hot spot” in the VCE 200 such that when users' avatars 208, 209, 210 are placed by users 201, 202, 203 on the hot spot, the CT is initiated. In a further embodiment, interaction with whiteboard 204 occurs upon engagement of avatars 208, 209, 210 with whiteboard 204, for example, when one or more avatars 208, 209, 210 begin writing, drawing or otherwise engage with the whiteboard 204.

Upon detecting and triggering of the CT invocation trigger, users 201, 202, 203 may begin use of the CT in the real world. Use of the CT will occur in the real world such that users 201, 202, 203 collaborate with the full features and functionality of the tool which are available in the real world, without breaking the collaborative flow initiated in the virtual world. User interaction may include acceptance by the tool of user input. For example, in one embodiment users 201, 202, 203 may draw with a drawing tool. In another embodiment, for example, where the CT is an audio or visual file, users may only listen or watch without making any alterations to the file.

Where users' 201, 202, 203 interactions with the tool result in at least one alteration, a second application state is generated which reflects the users' alteration(s). In one embodiment, for example, such as a drawing tool, a first application state of a drawing is presented to users 201, 202, 203. Upon alteration of the drawing by editing or mark-up, for example, a second application state of the drawing is presented to the users 201, 202, 203. The second application state, in one embodiment, may not result in a visible change to the first application state. For example, users may collaboratively share a blank web form (a first application state) and enter text into various fields and hit a “Submit” button. The form, where fields have been erased after submission (a second application state), may look identical to the form in the first application state. However, a non-visible change has occurred in data, which change may be stored in a back-end database.

Once users 201, 202, 203 have completed use of the CT, users 201, 202, 203 are returned to the VCE 200. Completion of use of the CT may occur, in one embodiment, upon an active indication by the user. In one embodiment, an active indication can include, for example, selection of an expansion icon, selection in a frame box, activation of a dismissal control; or other forms of user-initiated and controlled actions or other conditions. Alternatively or additionally, dismissal of the collaborative tool may be passive such that rendering of the tool in the real world environment is allowed to fade out after a predetermined amount of time, for example. In a further embodiment, dismissal can occur upon users' 201, 202, 203 engagement of an audio channel such that upon the start of conversation between users 201, 202, 203, rendering of the tool transitions back to the VCE 200.

It will be understood that the commencement of use of the tool in the real world and return of the users 201, 202, 203 upon completion of use of the tool to the virtual world may occur by use of a transition. Thus, upon users' 201, 202, 203 triggering of the invocation trigger which commences use of the CT, users 201, 202, 203 may be visually transitioned from a view of the first application state of the CT in the virtual world to a view of the first application state of the tool in the real world. Similarly, upon detection of completion of use of the CT, users 201, 202, 203 are transitioned back from the real world view of the CT to a view of the second application state of the CT in the virtual world. The transition may occur as a fade, a wipe, a pattern, or any other type of transition as is known to those of ordinary skill in the art.

In one embodiment, a computer is adapted to run the application(s), module(s), program(s) or other suitable software for enabling users to operate in a VCE 200 and utilize the collaborative tools therein. Users 201, 202, 203 respectively access the VCE 200, operate within the VCE 200 and communicate with other users 201, 202, 203 via a communications network.

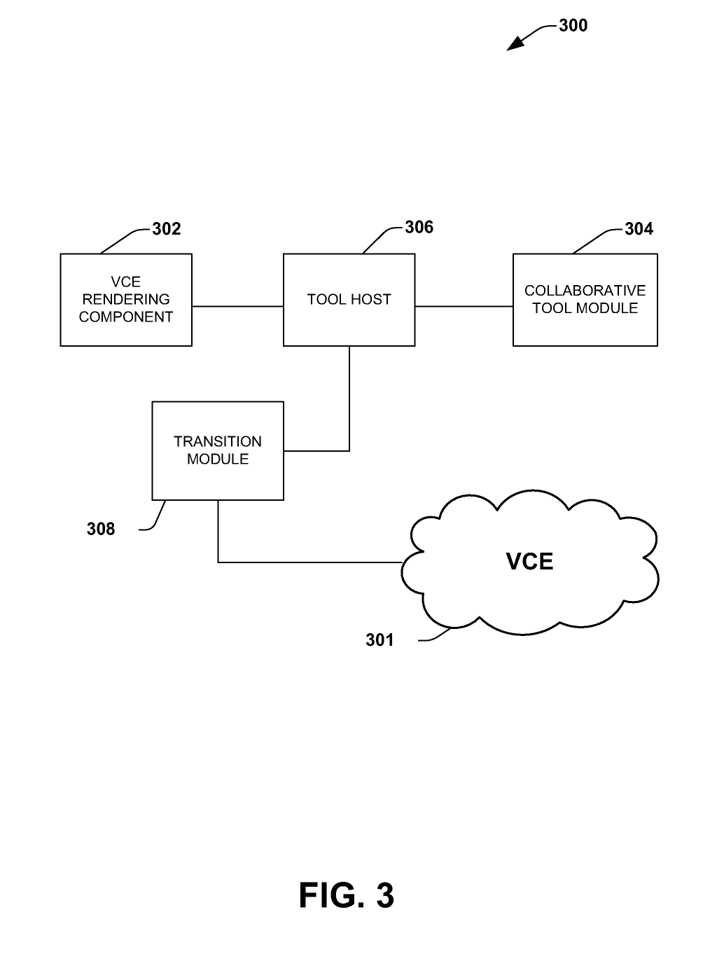

FIG. 3 illustrates a component block diagram of an exemplary system 300 by which users (e.g., 201, 202, 203 FIG. 2) may collaborate in a virtual environment 301 with collaborative tools integrated therein. The exemplary system 300 involves a VCE rendering component 302 which pictorializes and animates on a display component of multiple user's computer displays a virtual world, including users' avatars (e.g., 208, 209 210 FIG. 2) and one or more shared workspaces (e.g., 204 FIG. 2). The VCE rendering component 302 can further perform audio rendering of the VCE 301 on speakers, headphones or other audio devices. It can further be utilized to accept user input, such as a keyboard, a mouse or other like input.

VCE rendering component 302 includes a trigger related to a collaborative tool module 304. Users entering the VCE interact with one or more collaborative tools from the collaborative tool module 304. Tool module 304 contains one or more collaborative tools from which tools may be selected with which to collaborate in the VCE 301.

Tool host 306 comprises a wrapper configured to manage the collaborative experience of users within the VCE 301 and provide collaboration features. In one embodiment, tool host 306 may be provided to pre-configure a CT for use in the VCE 301 and facilitate the performance of various common tasks associated with users in the VCE 301. For example, tool host 306 may obtain files and information from users, load and activate in system memory the tool or tools to be run in the VCE 301, and determine access rights of users to use of the CT. In another embodiment, tool host 306 may be configured to mediate tool use during collaboration by, for example, accepting input from users where the tool being used is configured to do so, configuring the collaborative tool to reflect collaboration between avatars of the virtual world in the real world, and managing movement between one CT to another where more than one CT is available for use. In a further embodiment, tool host 306 may be configured to conclude the collaborative session upon completion by the users by saving and storing alterations made to the collaboration by the users, generating the second application state to be viewed in the VCE 301, and returning users to the virtual collaborative environment. Those of ordinary skill in the art may devise many techniques for configuring the tool host to manage the collaborative experience while implementing the techniques discussed herein.

In one variation of the system 300 described herein, a transition module 308 operatively connected to the VCE 301 and the tool host 306 is provided. The transition module 306, in one embodiment, is configured to initiate the collaborative tool module 304 upon one or more users activating the trigger. Additionally, once users have completed use of the CT from the tool module 304, transition module returns users to the virtual collaborative environment.

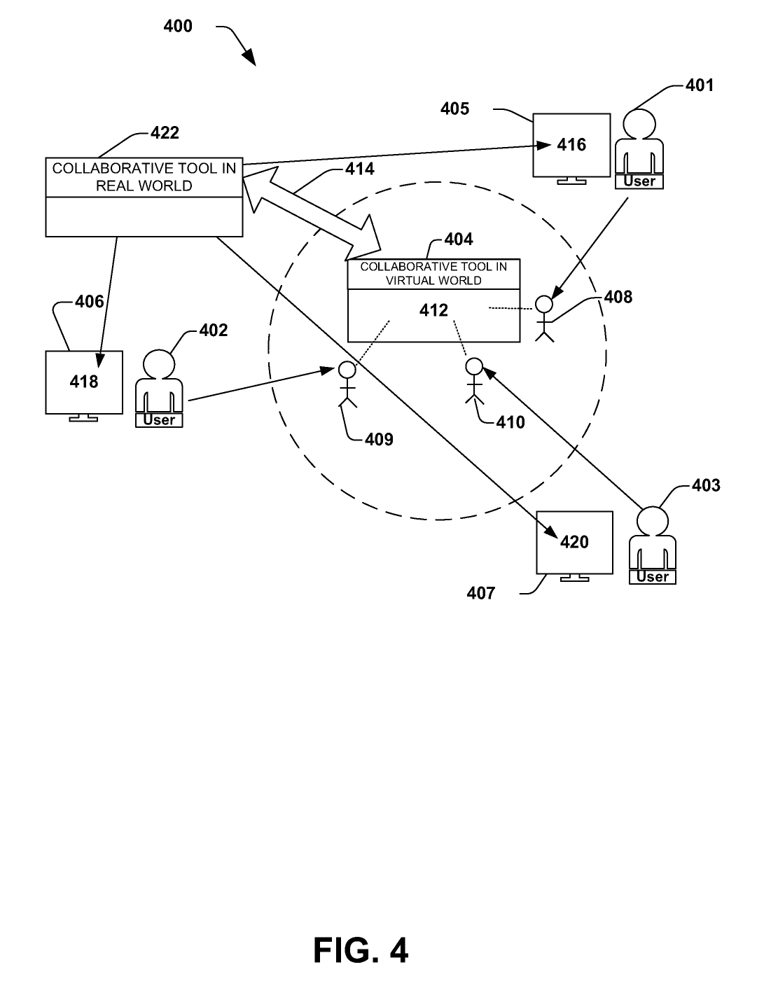

In FIG. 4 there is illustrated one embodiment of an exemplary application of a method in which a drawing CT is integrated into a VCE 400. VCE 400 includes users 401, 402, 403. Users 401, 402, 403 access VCE 400 through a network component. VCE 400 is displayed on user monitors 405, 406, 407 respectively. Users 401, 402, 403 are graphically represented within the VCE 400 by avatars 408, 409, 410, respectively. Within the VCE 400, a first application state of a collaborative tool is displayed on a shared workspace or whiteboard 404 within the VCE 400 and which is visible to users 401, 402, 403 simultaneously on user workstations 405, 406, 407. As users' avatars 408, 409, 410 approach the whiteboard and begin to interact with whiteboard 404, display 412 of the VCE 400 and collaborative tool in the virtual world on user workstations 405, 406, 407 transitions 414 to display 416, 418, 420 of the collaborative tool 420 in the real world on users' workstations 405, 406, 407.

Users 401, 402, 403 can alter the first application state of the collaborative tool displayed 416, 418, 420 on local workstations 405, 406, 407. Alterations can include, for example, opening of data and object files, drawing, writing, deleting, and moving of entries, among others. Any alteration performed by one user is simultaneously viewed by all other users. Alterations are then viewed on display 416, 418, 420 as a second application state of the CT. In this manner, users 401, 402, 403 are provided with the benefit of the full functionality and features of the CT outside of the VCE 400. Upon completion of users' alteration of the CT, the display will transition from the CT on the user's workstation 405, 406, 407 in the real world back to the display of the collaborative tool in a second application state on the whiteboard in the VCE 400.

Still another embodiment involves a computer-readable medium comprising processor-executable instructions configured to apply one or more of the techniques presented herein. An exemplary computer-readable medium that may be devised in these ways is illustrated in FIG. 500, wherein the implementation 500 comprises a computer-readable medium 502 (e.g., a CD-R, DVD-R, or a platter of a hard disk drive), on which is encoded computer-readable data 504. This computer-readable data 504 in turn comprises a set of computer instructions 506 configured to operate according to one or more of the principles set forth herein. In one such embodiment 508, the processor-executable instructions 506 may be configured to perform a method of using collaborative tools in a virtual environment 508, such as the exemplary method 100 of FIG. 1, for example. In another such embodiment, the processor-executable instructions 506 may be configured to implement a system for using collaborative tools in a virtual environment 508, such as the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

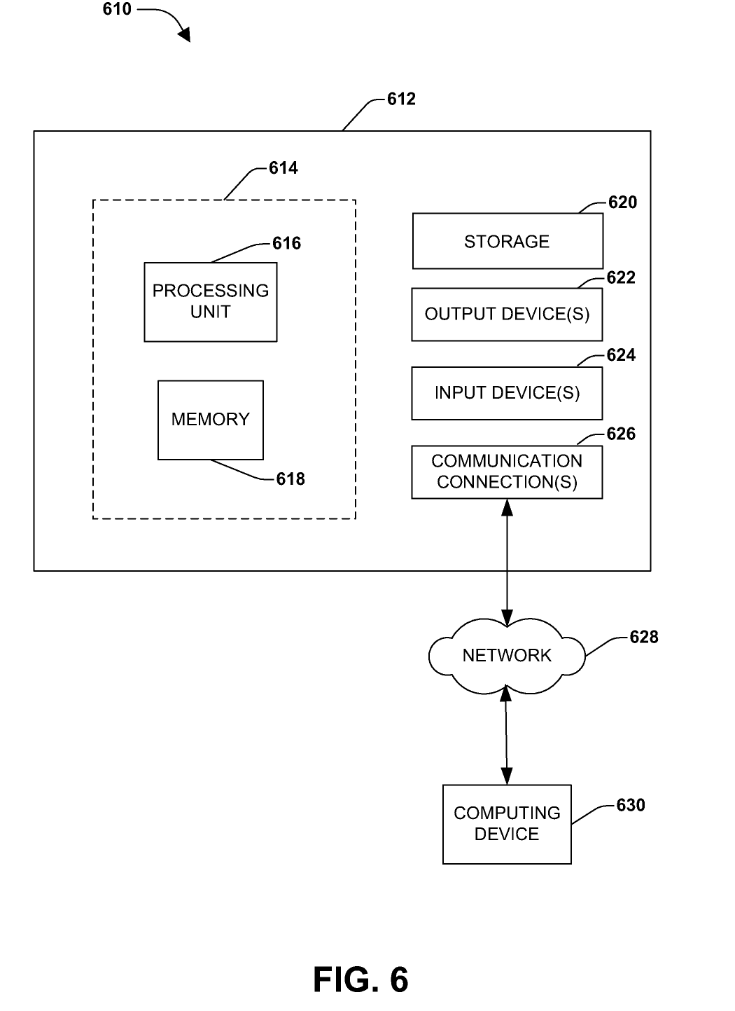

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 610 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described are not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Users' as used herein generally means one or more users, and not necessarily all of the users engaging in a particular activity concurrently.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of using a collaborative tool in a virtual collaborative environment, comprising:
rendering a first application state of a collaborative tool in a virtual collaborative environment;
presenting at least one collaborative tool invocation trigger in the virtual collaborative environment;
upon detecting the trigger, commencing use of the collaborative tool in a real world environment; and
upon detecting completion of use of the collaborative tool in the real world environment, returning one or more users to the virtual collaborative environment.

2. The method of claim, 1 comprising:
upon receiving at least one alteration of the collaborative tool from at least one user:
generating a second application state of the collaborative tool reflecting the alteration, and
presenting the second application state to the users.

3. The method of claim 2, comprising:
upon returning to the virtual collaborative environment, rendering the second application state of the collaborative tool in the virtual collaborative environment.

4. The method of claim 1, the tool invocation trigger comprising a user interaction with the collaborative tool, a hot spot, or a preconfigured proximity locator within the virtual collaborative environment.

5. The method of claim 1, the detecting completion of use of the collaborative tool comprising a passive indication or an active indication.

6. The method of claim 5, the passive indication comprising a predetermined passage of time and the active indication comprising dismissal of the tool by the user.

7. The method of claim 6, the returning to the virtual collaborative environment comprising a transition.

8. The method of claim 3, use of the collaborative tool comprising acceptance by the tool of input from the user.

9. The method of claim 2, the at least one alteration comprising:
a visible change between the first application state and the second application state; or
a non-visible change between the first application state and the second application state.

10. The method of claim 1, comprising communicating between the one or more users within the virtual collaborative environment.

11. The method of claim 9, the communicating comprising one or more of text discussion, audio commands, webcam, and/or mouse gesture.

12. The method of claim 1, the first application state of the collaborative tool rendered as a graphical representation of the tool to be used.

13. The method of claim 3, the commencement and returning comprising a transition.

14. The method of claim 1, the collaborative tool being preconfigured such that upon start-up of the collaborative tool, the tool is in a condition to render the first application state.

15. A system for integrating use of one or more tools in a virtual collaborative environment comprising:
at least one collaborative tool module;
a virtual collaborative environment rendering component having a trigger associated with the tool module; and
a tool host configured to manage a collaborative experience with regard to use of a collaborative tool.

16. The system of claim 15, the collaborative tool module comprising one or more collaborative tools.

17. The system of claim 16, the trigger configured to invoke start-up of one or more collaborative tools by the tool host.

18. The system of claim 15, the tool host management comprising configuring the collaborative tool to reflect collaboration between avatars of the virtual world in the real world.

19. The system of claim 15, comprising a transition module operatively connected to the virtual collaborative environment and the tool host, and configured to:
upon a user activating the trigger, invoke the tool host to initiate the collaborative tool; and
upon a user exiting from the collaborative tool in the collaborative tool module, return the user to the virtual collaborative environment.

20. A method of using a collaborative tool in a virtual collaborative environment, comprising:
rendering on at least one shared workspace in a virtual collaborative environment:
a first application state of a collaborative tool comprising:
a graphical representation of the collaborative tool, the collaborative tool being pre-configured such that upon start-up of the collaborative tool, the tool is in a condition to render the first application state;
presenting at least one collaborative tool invocation trigger in the virtual collaborative environment, the invocation trigger comprising:
a user interaction with the tool, a hot spot, or a preconfigured proximity locator within the virtual collaborative environment;
upon detecting and triggering of the trigger, commencing use of the collaborative tool in a real world environment;
receiving at least one alteration of the collaborative tool from at least one user to generate a second application state of the collaborative tool reflecting the alteration and presenting the second application state to the users, the at least one alteration comprising:
a visible change between the first application state and the second application state; or
a non-visible change between the first application state and the second application state;
detecting completion of the use of the collaborative tool, the detecting comprising:
a passive indication or an active indication;
returning the user to the virtual collaborative environment, the returning comprising a transition; and
rendering a second application state of the collaborative tool in the virtual collaborative environment.
